(19) United States
(12) Patent Application Publication
(10) Pub. No.: US 2024/0259123 A1
(43) Pub. Date: Aug. 1, 2024

(54) MOBILE PERSONAL AUDIO RECORDER FOR RADIO

(71) Applicant: Sony Group Corporation, Tokyo (JP)

(72) Inventor: Brant Candelore, Poway, CA (US)

(73) Assignee: Sony Group Corporation, Tokyo (JP)

(21) Appl. No.: 18/104,235

(22) Filed: Jan. 31, 2023

(51) Int. Cl. H04H 60/43; H04H 60/44

(52) U.S. Cl. CPC H04H 60/43; H04H 60/44

(57) ABSTRACT

Implementations generally relate to a mobile personal audio recorder (PAR) for radio. In some implementations, a method includes determining a target radio program for recording, where the radio program is an Advanced Television Systems Committee (ATSC) radio program, and where the target radio program is broadcast at a predetermined broadcast time. The method further includes receiving the target radio program while being broadcast. The method further includes recording the target radio program while being broadcast. The method further includes playing the target radio program for a user at a time that is different from the predetermined broadcast time.

### BACKGROUND

Content from broadcast over-the-air (OTA) radio is conventionally consumed real-time. A person typically listens to the content that is being broadcast at that moment on the station that the OTA radio is tuned to. In a typical scenario, a person gets in their car and randomly surfs stations or channels for music or talk radio shows to listen to. At a given moment, the person may or may not hear music or a radio talk content of interest. Alternatively, some people subscribe to services that distribute digital content over the internet live, which could be played in the car. However, this presumes that a network connection is available. If a person desires to listen to a particular talk radio show, the person typically needs to be driving at the specific time that the talk radio show is being broadcast.

### SUMMARY

Implementations generally relate to a mobile personal audio recorder (PAR) for radio. In some implementations, a system includes one or more processors, and includes logic encoded in one or more non-transitory computer-readable storage media for execution by the one or more processors. When executed, the logic is operable to cause the one or more processors to perform operations including: determining a target radio program for recording, where the radio program is an Advanced Television Systems Committee (ATSC) radio program, and where the target radio program is broadcast at a predetermined broadcast time; receiving the target radio program while being broadcast; recording the target radio program while being broadcast; and playing the target radio program for a user at a time that is different from the predetermined broadcast time.

With further regard to the system, in some implementations, the target radio program is a talk show radio program. In some implementations, the target radio program is a music radio program. In some implementations, the receiving and recording of the target radio program are performed at a mobile device that is integrated with a vehicle. In some implementations, the logic when executed is further operable to cause the one or more processors to perform operations including: determining a broadcast schedule of the target radio program; tuning to a frequency channel that airs the target radio program based on the broadcast schedule; and recording the target radio program while being broadcast. In some implementations, the logic when executed is further operable to cause the one or more processors to perform operations including: tracking a signal strength of the target radio program; detecting a drop in the signal strength; and compensating for the drop in the signal strength. In some implementations, the logic when executed is further operable to cause the one or more processors to perform operations including transferring the target radio program in digital form to a second mobile device.

In some implementations, a non-transitory computer-readable storage medium with program instructions thereon is provided. When executed by one or more processors, the instructions are operable to cause the one or more processors to perform operations including: determining a target radio program for recording, where the radio program is an Advanced Television Systems Committee (ATSC) radio program, and where the target radio program is broadcast at a predetermined broadcast time; receiving the target radio program while being broadcast; recording the target radio program while being broadcast; and playing the target radio program for a user at a time that is different from the predetermined broadcast time.

With further regard to the computer-readable storage medium, in some implementations, the target radio program is a talk show radio program. In some implementations, the target radio program is a music radio program. In some implementations, the receiving and recording of the target radio program are performed at a mobile device that is integrated with a vehicle. In some implementations, the instructions when executed are further operable to cause the one or more processors to perform operations including: determining a broadcast schedule of the target radio program; tuning to a frequency channel that airs the target radio program based on the broadcast schedule; and recording the target radio program while being broadcast. In some implementations, the instructions when executed are further operable to cause the one or more processors to perform operations including: tracking a signal strength of the target radio program; detecting a drop in the signal strength; and compensating for the drop in the signal strength. In some implementations, the instructions when executed are further operable to cause the one or more processors to perform operations including transferring the target radio program in digital form to a second mobile device.

In some implementations, a method includes: determining a target radio program for recording, where the radio program is an Advanced Television Systems Committee (ATSC) radio program, and where the target radio program is broadcast at a predetermined broadcast time; receiving the target radio program while being broadcast; recording the target radio program while being broadcast; and playing the target radio program for a user at a time that is different from the predetermined broadcast time.

With further regard to the method, in some implementations, the target radio program is a talk show radio program. In some implementations, the target radio program is a music radio program. In some implementations, the receiving and recording of the target radio program are performed at a mobile device that is integrated with a vehicle. In some implementations, the method further includes: determining a broadcast schedule of the target radio program; tuning to a frequency channel that airs the target radio program based on the broadcast schedule; and recording the target radio program while being broadcast. In some implementations, the method further includes: tracking a signal strength of the target radio program; detecting a drop in the signal strength; and compensating for the drop in the signal strength.

A further understanding of the nature and the advantages of particular implementations disclosed herein may be realized by reference of the remaining portions of the specification and the attached drawings.

### BRIEF DESCRIPTION OF THE DRAWINGS

FIG. 1 is a block diagram of an example network environment for implementing a mobile personal audio recorder (PAR) for radio, which may be used for some implementations described herein.

FIG. 2 is an example flow diagram for implementing a mobile PAR for radio, according to some implementations.

FIG. 3 is a block diagram of an example network environment, which may be used for some implementations described herein.

FIG. 4 is a block diagram of an example computer system, which may be used for some implementations described herein.

### DETAILED DESCRIPTION

Implementations described herein enable, facilitate, and manage a mobile personal audio recorder (PAR) for radio. The PAR may be a part of an entertainment or media system of a vehicle, boombox, or other media system. As described in more detail herein, it records over-the-air (OTA) radio content at scheduled times. The PAR scans the OTA spectrums to gather information in order to create an audio guide of scheduled content, as well as record target radio programs for future listening by a user at a time that is convenient for the user. As such, the user may simply listen to his or her own content that has been previously recorded. The content and metadata may be in Advanced Television Systems Committee (ATSC) standards format (e.g., ATSC 3.0 format, etc.).

As described in more detail herein, in various implementations, a system determines a target radio program for recording, where the target radio program is broadcast at a predetermined broadcast time. The system then receives the target radio program while being broadcast. The system records the target radio program while being broadcast. The system subsequently plays the target radio program for a user at a time that is different from the predetermined broadcast time.

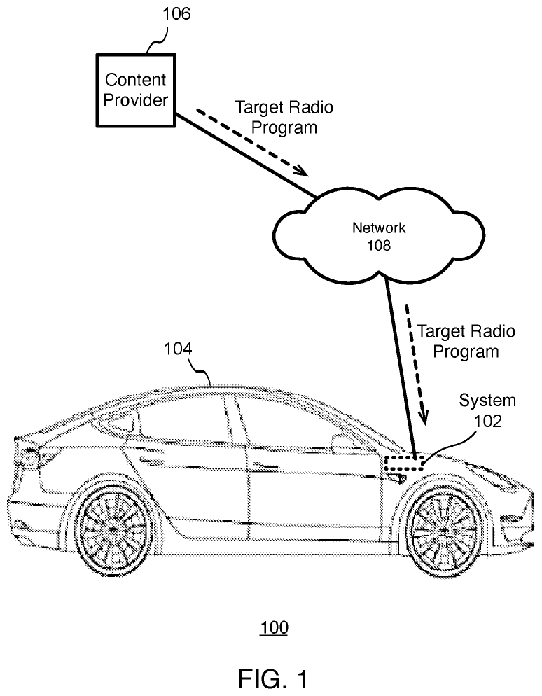

FIG. 1 is a block diagram of an example network environment 100 for implementing a mobile personal audio recorder (PAR) for radio, which may be used for some implementations described herein. In various implementations, network environment 100 includes a system such as system 102, which functions as a PAR for radio. As such, system 102 may also be referred to as PAR 102. System 102 resides in a vehicle such as vehicle 104. System 102 communicates with content provider 106 via a network such as network 108. Network 108 may be any suitable communication network such as a Bluetooth network, a Wi-Fi network, the internet, satellite network, etc.

In some implementations, system 102 may also be integrated with another system of vehicle 104, such as the main computer system of vehicle 104. Alternatively, in some implementations, system 102 may a stand-alone unit or system that resides in vehicle 104. In a scenario where system 102 is a stand-alone system, a user may remove system 102 for portability. For example, in some scenarios, system 102 may have a quick-release mechanism, where the user may conveniently uncouple system 102 from vehicle 104. As such, the user may hand-carry system 102 elsewhere (e.g., into a workplace, into a residence, etc.). In some implementations, system 102 may be coupled to or integrated with a portable boombox (not shown). In some implementations, system 102 may be removably coupled to a vehicle such as vehicle 104, removably coupled to a boombox (not shown), and/or removably coupled to another media system (not shown) such as one on the residence or workplace of the user. In various implementations, system 102 may be powered by a separate battery, or may be powered by another system with a separate battery as a backup power supply. System 102 may prioritize where it draws power from (e.g., another system's power source first, backup battery second, etc.) if the vehicle is turned off.

In the example implementation shown, vehicle 104 is a car or sedan. Vehicle 104 may be another type of vehicle. For example, in some implementations, vehicle 104 may be a truck, recreational vehicle, etc. In some implementations, vehicle 104 may be a watercraft, aircraft, etc.

As described in more detail herein, system 102 receives content such as a target radio program from a content provider such as content provider 106. System 102 may receive the target radio program whether a user (not shown) is present in vehicle 104 or not. This enables system 102 to receive the target radio program at any time and also enables system 102 to record the target radio program at any time, independent of the user manually controlling system 102.

For ease of illustration, FIG. 1 shows one block for each of system 102, vehicle 104, content provider 106, and network 108. There may be any number of systems, vehicles, content providers, and networks. For example, system 102 may access different target radio programs from one or more different content providers. In other implementations, environment 100 may not have all of the components shown and/or may have other elements including other types of elements instead of, or in addition to, those shown herein.

While system 102 performs implementations described herein, in other implementations, any suitable component or combination of components associated with system 102 or any suitable processor or processors associated with system 102 may facilitate performing the implementations described herein. For example, system 102 may be a part of a larger personal audio recorder (PAR) platform for multiple users and vehicles.

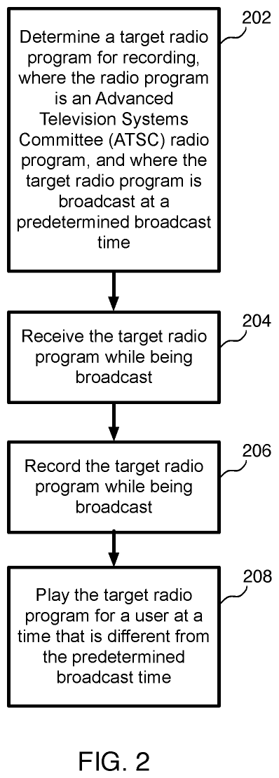

FIG. 2 is an example flow diagram for implementing a mobile PAR for radio, according to some implementations. Referring to both FIGS. 1 and 2, a method is initiated at block 202, where a system such as system 102 determines a target radio program for recording. In some implementations, system 102 may determine if the target radio program is based on user input. For example, the system may receive the title of the target radio program or a scheduled day and time from the user, where the user enters or selects such information from a user interface associated with system 102. This would a situation where the user knows the target radio program in advance. System 102 may enable the user to input the radio frequency and time to record a program. If the content is in ATSC 3.0 format, the system may scan the available radio broadcasts to obtain program scheduling information from each radio station. This data may be carrouseled in the data stream in order to create a radio channel programming guide without the need for an Internet connection. The radio channel programming guide may then be perused by the user to schedule recordings. Alternatively, the system may receive a link in the data stream from a radio station, which would allow out-of-band delivery of the program scheduling information. Incidentally, out-of-band delivery would allow a means to acquire packets that may have been corrupted on reception if supported by the radio service.

In some implementations, system 102 may receive a control signal (e.g., a record signal from a record button, etc.) that is initiated by the user. This would a situation where the user does not necessarily know the target radio program in advance, and where the user may spontaneously hear the target radio program being broadcast. In this situation, the system may enable the user to indicate via a command to the system (e.g., the user tapping a record button, the user verbally speaking a record command, etc.).

In some implementations, system 102 may offer to record a particular target radio program when the user tunes to the radio program. The system may enable the user to record only the current radio program being broadcast and/or may enable the user to record future episodes as desired. Alternatively, if the user is not be able to tune the appropriate frequency channel during the broadcast times, the system may provide alternate broadcast times or a guide of alternative radio programs to the user that may be tuned at that moment. Alternatively, as the scenario may entail a mobile entertainment system, system 102 may receive the target program from a duplicate transmission from a different radio station. For example, syndicated radio shows are often sold around the country for delivery at the same exact time. As such, when a vehicle leaves an area with a particular station, the vehicle may be in the region of a broadcast from a different station. In various implementations, the system may compare the program ID of content from alternate stations to determine whether the content is the same program and if so to continue playing or recording that content.

In various implementations, the target radio program is broadcast over-the-air and is broadcast at a predetermined broadcast time. For ease of illustration, various implementations are described herein in the context of a single target radio program, these implementations also apply to multiple target radio programs and may be sourced by different, multiple content providers. In various implementations, system 102 functions as a personal audio recorder (PAR) personal video recorder. System 102 may also be used for broadcast over-the-air (OTA) radio content (e.g., ATSC 3.0, etc.). In some implementations, system 102 may also function as a personal video recorder (PVR). As such, while various implementations are described herein in the context of a PAR, these implementations, may also apply to a PVR.

In various implementations, the target radio program is a talk show radio program. In some implementations, the system determines if the target radio program is syndicated. Talk show radio programs are often syndicated and broadcast by different content providers. Talk show radio programs are also often scheduled to be broadcast at predetermined days and times. In various implementations, the system may perform internet searches to determine the predetermined scheduled days and times of the particular target radio talk show. For example, the schedule may be searched and found on a website that is associated with the target radio program.

In various implementations, the target radio program is a music radio program. The radio program may be associated with a particular content provider, radio program, and/or disc jockey (DJ). In various implementations, the system may perform internet searches to determine the predetermined scheduled days and times of the particular music radio program. For example, the schedule may be searched and found on a website that is associated with the target music radio program. Similar to a talk show program, the system may collect music radio programming schedule times by scanning the available radio channels to gather the program scheduling information that may be carrouseled there.

At block 204, system 102 receives the target radio program while being broadcast. As indicated herein, in some implementations, system 102 may be a separate stand-alone device such as a mobile device that resides in vehicle 104. In some implementations, system 102 may be a mobile device that is removably coupled to vehicle 104. In some implementations, the system may be a mobile device that is integrated with vehicle 104. Regardless of the configuration of system 102, system 102 is configured to receive and record the target radio program.

In various implementations, the user need not be present when the system receives the target radio program. For example, the user might not be in the vehicle (e.g., commuting, running errands, etc.), and may instead be at home or at work. As such, the system be in a standby mode while the vehicle is off. When the target radio program is broadcast, the vehicle may remain off and the system may automatically turn on or may wake up without user intervention in order to receive the target radio program while being broadcast.

At block 206, system 102 records the target radio program while being broadcast. System 102 may store the recorded target radio program locally on a storage unit integrated with system 102, locally in a storage unit that is integrated with vehicle 104, and/or remotely in a storage location in the cloud. In some implementations, if the received target radio program is encrypted or otherwise protected, the system may decrypt the target radio program before recording. In some implementations, after recording, the system may re-encrypt the target radio program.

System 102 may communicate with other media devices such as a primary car radio or secondary car radio, and/or with a smartphone. In some implementations, system 102 may sync up with one or more other media devices to learn which pre-recorded programs the user had already listened to. The system need not record such already-watched episodes.

At block 208, system 102 plays the target radio program for a user at a time that is different from the predetermined broadcast time. System 102 may enable the user to access the recorded target radio program from any of these storage locations. As such, system 102 may enable the user to play the recorded target radio program directly from system 102 or from another media system to which system 102 sends the recorded target radio program.

Although the steps, operations, or computations may be presented in a specific order, the order may be changed in particular implementations. Other orderings of the steps are possible, depending on the particular implementation. In some particular implementations, multiple steps shown as sequential in this specification may be performed at the same time. Also, some implementations may not have all of the steps shown and/or may have other steps instead of, or in addition to, those shown herein.

In various implementations, system 102 receives an indication that the target radio program is currently being broadcast. System 102 determines a frequency channel that is airing the target radio program. System 102 ascertains a start time and an end time of the target radio program based on a time of the indication. System 102 tunes to the frequency channel at a future time based the ascertaining. System 102 records the target radio program while being broadcast.

In some scenarios, the target radio program may be the first showing or episode that is broadcast. In such scenarios, the system may determine that no previous episodes exist. In such a situation, the system may log or mark the time at which the current episode is currently playing. The system may search immediately or in the future for a subsequent episode that is broadcast. In various example scenarios described herein, the term radio program, radio program episode, and episode may be used interchangeably. For example, when referring to the recorded target radio program, it could mean a unique stand-along radio program. It could also mean a particular episode that is associated with an on-going target radio program (e.g., a weekly target radio program).

As such, the system may determine a schedule for the target radio program from a found schedule that arises and/or ascertain a schedule for the target radio program based on a time pattern of the target radio program being broadcast.

In an example implementation, system 102 determines a broadcast schedule of the target radio program. System 102 tunes to a frequency channel that airs the target radio program based on the broadcast schedule. System 102 records the target radio program while being broadcast. System 102 may record the target radio program while being broadcast in accordance with the broadcast schedule, where the broadcast schedule contains the predetermined broadcast time. In some scenarios, the system might initially catch a given radio program in the middle of the given episode, where the episode has already started. The system may ascertain the starting time of the program based on the end time of the program. For example, the system may start tuning into the radio program at 9:35 am, and system may determine that the radio program ends at 10:00 am. If the system determines that the radio program is one-hour long, the system may then ascertain that the start time was 9:00 am. As such, the system may record the next episode of the radio program a week later on the same frequency channel and at the same 9:00 am time. In some implementations, the system may search the internet to confirm the next start time of the radio program. The system may also determine that a scheduled radio program may play on multiple days and may play multiple times a day. The system may select one of the broadcast times to record. The system may skip repeat episodes the repeat throughout the day, similar to how some news broadcasts repeat throughout the day.

In various implementations, system 102 tracks a signal strength of the target radio program. In some scenarios, system 102 may detect a drop in the signal strength. The system may detect that the drop in the signal strength falls below a predetermined threshold. This would indicate a weak or weakening signal. This could occur, for example, as the system tracks the signal strength of the target radio program while the system travels across a geographic area. In various implementations, system 102 may compensate for the drop in the signal strength. In some implementations, the system may compensate for the drop in signal strength by searching for content associated with the target radio program on the internet. The system may access an alternative source of the target radio program, and then patch in the program for the user to listen to without or with minimal disruption to the radio program.

The system may access the alternative version of the radio program from a storage location, from an alternative broadcast, etc. In some embodiments, if the system is not able to locate an alternative version of the radio program being broadcast, the system may offer the user with another available episode of the target radio program. For example, the episode may be a rerun that the user has already heard before or may be a rerun that was already broadcast but that the user has not heard yet. The system may also find a particular version of the target radio program on a different day, in which case the system may record the radio program at the appropriate next opportunity so that the user can listen to the recorded version at a future time.

In various implementations, system 102 transfers the target radio program in digital form to a second mobile device. The enables the user to conveniently listen to the target radio program at any convenient location (e.g., at home, in the workplace, etc.).

Implementations described herein provide various benefits. For example, implementations enable a user to access and record particular radio programs, including talk show programs, music programs, etc., even if the user is not physically at the vehicle of the user during the designated broadcast times. Implementations described herein also enable the user to listen to recorded radio programs at a time that is convenient for the user.

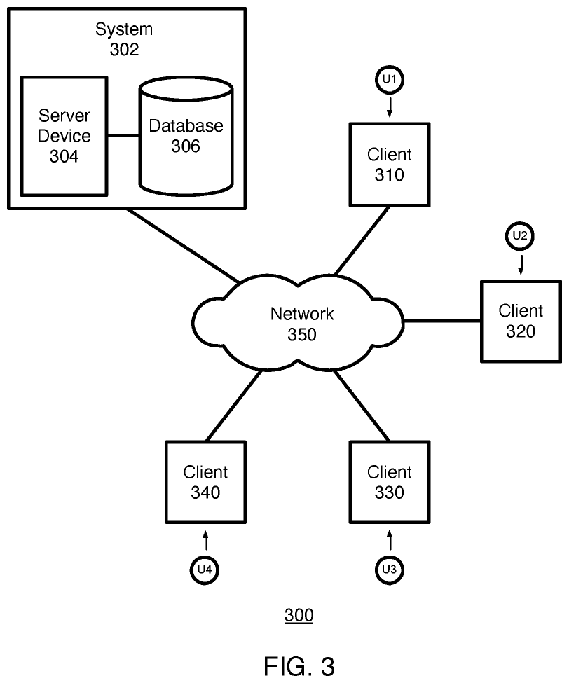

FIG. 3 is a block diagram of an example network environment 300, which may be used for some implementations described herein. In some implementations, network environment 300 includes a system 302, which includes a server device 304 and a database 306. For example, system 302 may be used to facilitate implementation of system 102 of FIG. 1, as well as to perform implementations described herein. For example, as indicated above, system 102 may be a part of a larger personal audio recorder (PAR) platform for multiple users and vehicles. In such a scenario, system 102 of FIG. 1 may communicate as a client such as client device 310 with system 302 to access variety of services offered by system 302. For example, system 302 may provide subscription services for receiving different radio programs. System 302 may provide administrative and account services for a PAR system such as system 102, or similar services for content providers, etc.

Network environment 300 also includes client devices 310, 320, 330, and 340, which may communicate with system 302 and/or may communicate with each other directly or via system 302. Network environment 300 also includes a network 350 through which system 302 and client devices 310, 320, 330, and 340 communicate. Network 350 may be any suitable communication network such as a Wi-Fi network, Bluetooth network, the Internet, etc.

For ease of illustration, FIG. 3 shows one block for each of system 302, server device 304, and network database 306, and shows four blocks for client devices 310, 320, 330, and 340. Blocks 302, 304, and 306 may represent multiple systems, server devices, and network databases. Also, there may be any number of client devices. In other implementations, environment 300 may not have all of the components shown and/or may have other elements including other types of elements instead of, or in addition to, those shown herein.

While server device 304 of system 302 performs implementations described herein, in other implementations, any suitable component or combination of components associated with system 302 or any suitable processor or processors associated with system 302 may facilitate performing the implementations described herein.

In the various implementations described herein, a processor of system 302 and/or a processor of any client device 310, 320, 330, and 340 cause the elements described herein (e.g., information, etc.) to be displayed in a user interface on one or more display screens.

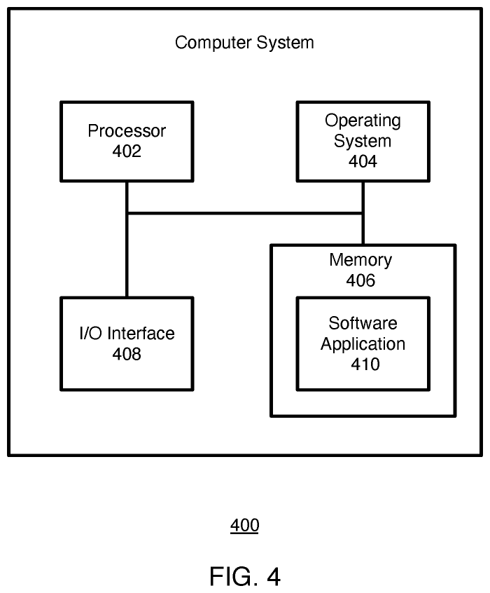

FIG. 4 is a block diagram of an example computer system 400, which may be used for some implementations described herein. For example, computer system 400 may be used to implement server device 404 of FIG. 4 and/or system 102 of FIG. 1, as well as to perform implementations described herein. In some implementations, computer system 400 may include a processor 402, an operating system 404, a memory 406, and an input/output (I/O) interface 408.

In various implementations, I/O interface 408 may be coupled to any appropriate receivers (not shown) for receiving a broadcast radio program. The receiver may be an analogue receiver, a digital receiver, or combination thereof. The receiver may receive target radio programs over the air and/or via a digital network.

In various implementations, processor 402 may be used to implement various functions and features described herein, as well as to perform the method implementations described herein. While processor 402 is described as performing implementations described herein, any suitable component or combination of components of computer system 400 or any suitable processor or processors associated with computer system 400 or any suitable system may perform the steps described. Implementations described herein may be carried out on a user device, on a server, or a combination of both.

Computer system 400 also includes a software application 410, which may be stored on memory 406 or on any other suitable storage location or computer-readable medium. Software application 410 provides instructions that enable processor 402 to perform the implementations described herein and other functions. Software application may also include an engine such as a network engine for performing various functions associated with one or more networks and network communications. The components of computer system 400 may be implemented by one or more processors or any combination of hardware devices, as well as any combination of hardware, software, firmware, etc.

For ease of illustration, FIG. 4 shows one block for each of processor 402, operating system 404, memory 406, I/O interface 408, and software application 410. These blocks 402, 404, 406, 408, and 410 may represent multiple processors, operating systems, memories, I/O interfaces, and software applications. In various implementations, computer system 400 may not have all of the components shown and/or may have other elements including other types of components instead of, or in addition to, those shown herein.

Although the description has been described with respect to particular implementations thereof, these particular implementations are merely illustrative, and not restrictive. Concepts illustrated in the examples may be applied to other examples and implementations.

In various implementations, software is encoded in one or more non-transitory computer-readable media for execution by one or more processors. The software when executed by one or more processors is operable to perform the implementations described herein and other functions.

Any suitable programming language can be used to implement the routines of particular implementations including C, C++, C#, Java, JavaScript, assembly language, etc. Different programming techniques can be employed such as procedural or object oriented. The routines can execute on a single processing device or multiple processors. Although the steps, operations, or computations may be presented in a specific order, this order may be changed in different particular implementations. In some particular implementations, multiple steps shown as sequential in this specification can be performed at the same time.

Particular implementations may be implemented in a non-transitory computer-readable storage medium (also referred to as a machine-readable storage medium) for use by or in connection with the instruction execution system, apparatus, or device. Particular implementations can be implemented in the form of control logic in software or hardware or a combination of both. The control logic when executed by one or more processors is operable to perform the implementations described herein and other functions. For example, a tangible medium such as a hardware storage device can be used to store the control logic, which can include executable instructions.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (Saas) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

What is claimed is:

1. A system comprising:
one or more processors; and
logic encoded in one or more non-transitory computer-readable storage media for execution by the one or more processors and when executed operable to cause the one or more processors to perform operations comprising:
determining a target radio program for recording, wherein the radio program is an Advanced Television Systems Committee (ATSC) radio program, and wherein the target radio program is broadcast at a predetermined broadcast time;
receiving the target radio program while being broadcast;
recording the target radio program while being broadcast; and
playing the target radio program for a user at a time that is different from the predetermined broadcast time.

2. The system of claim 1, wherein the target radio program is a talk show radio program.

3. The system of claim 1, wherein the target radio program is a music radio program.

4. The system of claim 1, wherein the receiving and recording of the target radio program are performed at a mobile device that is integrated with a vehicle.

5. The system of claim 1, wherein the logic when executed is further operable to cause the one or more processors to perform operations comprising:
determining a broadcast schedule of the target radio program;
tuning to a frequency channel that airs the target radio program based on the broadcast schedule; and
recording the target radio program while being broadcast.

6. The system of claim 1, wherein the logic when executed is further operable to cause the one or more processors to perform operations comprising:
tracking a signal strength of the target radio program;
detecting a drop in the signal strength; and
compensating for the drop in the signal strength.

7. The system of claim 1, wherein the logic when executed is further operable to cause the one or more processors to perform operations comprising transferring the target radio program in digital form to a second mobile device.

8. A non-transitory computer-readable storage medium with program instructions stored thereon, the program instructions when executed by one or more processors are operable to cause the one or more processors to perform operations comprising:
determining a target radio program for recording, wherein the radio program is an Advanced Television Systems Committee (ATSC) radio program, and wherein the target radio program is broadcast at a predetermined broadcast time;
receiving the target radio program while being broadcast;
recording the target radio program while being broadcast; and
playing the target radio program for a user at a time that is different from the predetermined broadcast time.

9. The computer-readable storage medium of claim 8, wherein the target radio program is a talk show radio program.

10. The computer-readable storage medium of claim 8, wherein the target radio program is a music radio program.

11. The computer-readable storage medium of claim 8, wherein the receiving and recording of the target radio program are performed at a mobile device that is integrated with a vehicle.

12. The computer-readable storage medium of claim 8, wherein the instructions when executed are further operable to cause the one or more processors to perform operations comprising:
determining a broadcast schedule of the target radio program;
tuning to a frequency channel that airs the target radio program based on the broadcast schedule; and
recording the target radio program while being broadcast.

13. The computer-readable storage medium of claim 8, wherein the instructions when executed are further operable to cause the one or more processors to perform operations comprising:
tracking a signal strength of the target radio program;
detecting a drop in the signal strength; and
compensating for the drop in the signal strength.

14. The computer-readable storage medium of claim 8, wherein the instructions when executed are further operable to cause the one or more processors to perform operations comprising transferring the target radio program in digital form to a second mobile device.

15. A computer-implemented method comprising:
determining a target radio program for recording, wherein the radio program is an Advanced Television Systems Committee (ATSC) radio program, and wherein the target radio program is broadcast at a predetermined broadcast time;
receiving the target radio program while being broadcast;
recording the target radio program while being broadcast; and
playing the target radio program for a user at a time that is different from the predetermined broadcast time.

16. The method of claim 15, wherein the target radio program is a talk show radio program.

17. The method of claim 15, wherein the target radio program is a music radio program.

18. The method of claim 15, wherein the receiving and recording of the target radio program are performed at a mobile device that is integrated with a vehicle.

19. The method of claim 15, further comprising:
determining a broadcast schedule of the target radio program;
tuning to a frequency channel that airs the target radio program based on the broadcast schedule; and
recording the target radio program while being broadcast.

20. The method of claim 15, further comprising:
tracking a signal strength of the target radio program;
detecting a drop in the signal strength; and
compensating for the drop in the signal strength.
